(19) United States
(12) Patent Application Publication
(10) Pub. No.: US 2010/0151308 A1
(43) Pub. Date: Jun. 17, 2010

(54) INCREASED RESISTANCE TO THERMAL RUNAWAY THROUGH DIFFERENTIAL HEAT TRANSFER

(75) Inventors: Weston Arthur Hermann, Palo Alto, CA (US); Scott Ira Kohn, Menlo Park, CA (US); Eugene Michael Berdichevsky, San Francisco, CA (US); Peng Zhou, El Cerrito, CA (US)

Correspondence Address: SCHWEGMAN, LUNDBERG & WOESSNER, P.A., P.O. BOX 2938, MINNEAPOLIS, MN, 55402, US

(73) Assignee: Tesla Motors, Inc., San Carlos, CA (US)

(21) Appl. No.: 12/333,631

(22) Filed: Dec. 12, 2008

(51) Int. Cl. H01M 10/50

(52) U.S. Cl. 429/120

(57) ABSTRACT

One embodiment includes a housing, a first battery cell having a first cell thermal capacitance, the first cell fixedly disposed in the housing, a second battery cell having a second cell thermal capacitance, the second cell fixedly disposed in the housing a minimum air gap away from the first cell, the minimum air gap having an air gap thermal resistance and a heat conductor disposed adjacent each of the cells, with the heat conductor having a heat conductor heat capacitance. A combination of the first cell thermal capacitance, the second cell thermal capacitance, the heat conductor thermal capacitance and the air gap is sufficient to restrict heat flow from the first cell to the second cell during a thermal runaway event of the first cell, the heat flow restricted such that the second cell temperature remains less than a temperature sufficient to cause thermal runaway in the second cell.

### BACKGROUND

There are a number of negative aspects to burning fuel in an internal combustion engine to provide for transportation, such as cost, pollution, and the unnecessary depletion of natural resources. Vehicles having electric or partially electric propulsion machinery address some of these problems. Batteries may be used to power these vehicles. Systems and methods to maintain desired temperatures for these batteries are needed, as batteries that heat up excessively could be damaged.

### BRIEF DESCRIPTION OF THE DRAWINGS

FIG. 1 is a high level diagram of a vehicle, according to some embodiments.

FIG. 2 is top view of a plurality of battery cells, electrical conductors and heat conductors, according to some embodiments.

FIG. 3 is a schematic of thermal relationships between a plurality of battery cells and a heat conductor, according to some embodiments.

FIG. 4 is a schematic of thermal relationships between a plurality of battery cells and a heat conductor, according to some embodiments.

FIG. 5 shows a top view of an additional configuration of cells, according to some embodiments.

FIG. 6 shows a top view of an additional configuration of cells, according to some embodiments.

FIG. 7 is a graph showing a cell at a normal state of charge that enters thermal runaway (“TR”), and a cell at a normal state of charge that does not enter TR, with a high ratio of high thermal resistivity to a heat conductor to thermal resistivity with another cell, according to some embodiments.

FIG. 8 is a graph showing a cell at a normal state of charge that enters TR, and a cell at a normal state of charge that does not enter TR, with a low ratio of high thermal resistivity to a heat conductor to thermal resistivity with another cell, according to some embodiments.

FIG. 9 is a graph showing a cell at a high state of charge that enters TR, and a cell at a high state of charge that does not enter TR, with a high ratio of high thermal resistivity to a heat conductor to thermal resistivity with another cell, according to some embodiments.

FIG. 10 is a graph showing a cell at a high state of charge that enters TR, and a cell at a high state of charge that does not enter TR, with a low ratio of high thermal resistivity to a heat conductor to thermal resistivity with another cell, according to some embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The systems and methods disclosed herein provide a battery comprised of cells. In some embodiments, the cells are lithium. Lithium cells have been known to enter thermal runaway (“TR”). The subject matter described below provides novel system and methods that deter a cell in TR from starting a cascading chain reaction of cells in TR. This is achieved by making it difficult for a cell in TR to conduct heat to a neighbor cell, and easy for it to conduct heat to a heat conductor that transfers heat away from the cell in TR and, in some instances, from the neighboring cells. An air gap of a predetermined size is used to make it difficult to conduct heat from one cell to the next in some embodiments.

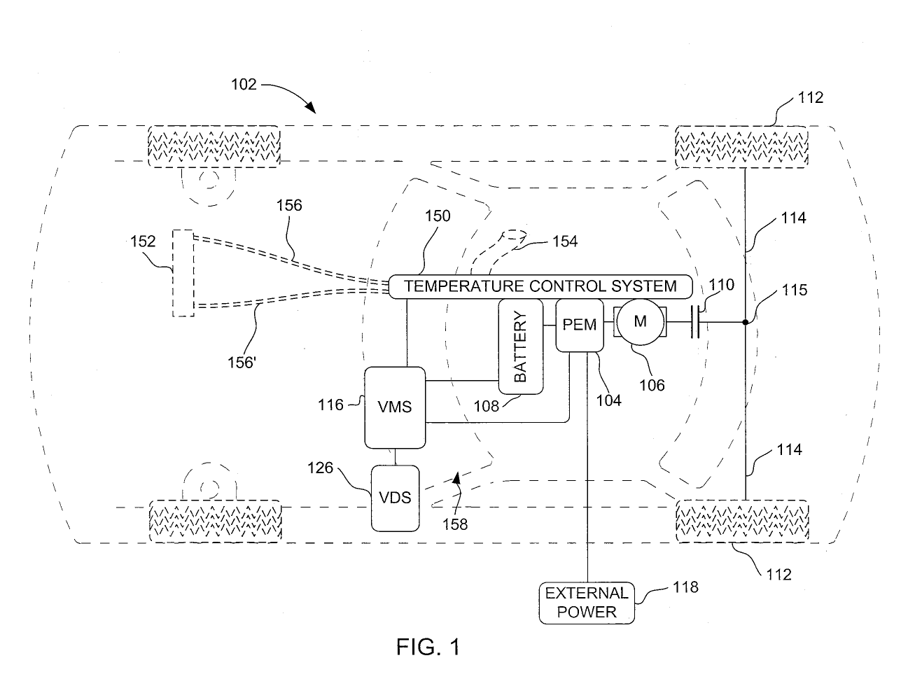

FIG. 1 shows a vehicle system 100, according to some embodiments of the present subject matter. In various embodiments, the vehicle 102 is an electric or hybrid electric vehicle and includes a vehicle propulsion battery 108 and at least one propulsion motor 106 for converting battery energy into mechanical motion, such as rotary motion.

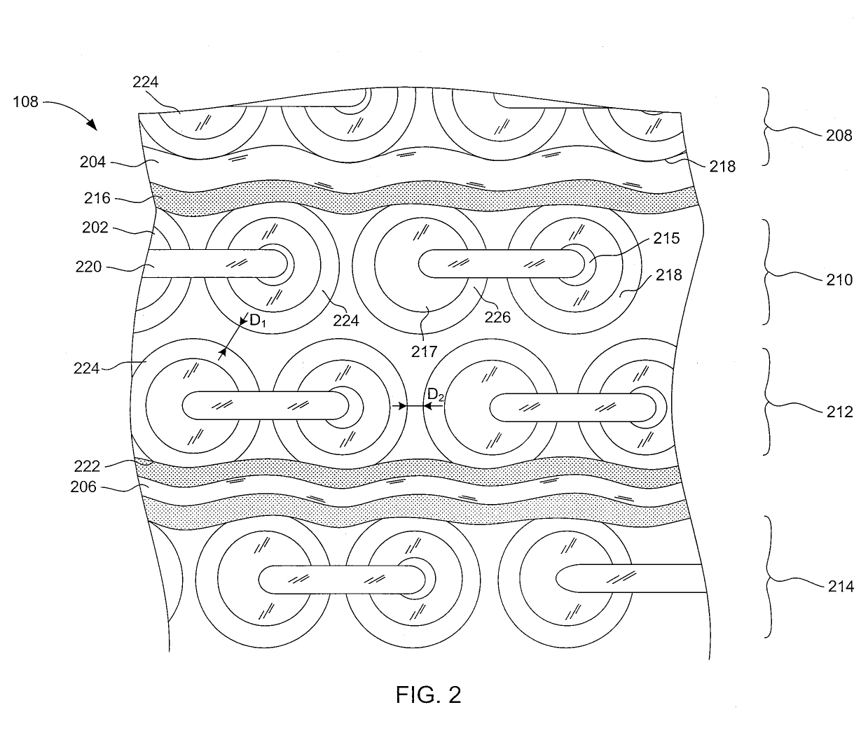

The present subject matter includes embodiments in which the battery 108 is a secondary battery that is rechargeable using electricity rather than chemicals or other materials. Various battery chemistries may be used, including lithium ion chemistries such as lithium polymer, lithium iron phosphate, nickel metal hydride, lead acid, and other chemistries. The battery 108 includes improved thermal properties allowing it to have an increased volumetric energy density in some applications. This improvement is discussed below in association with FIGS. 2-10.

The vehicle propulsion battery 108 is a subcomponent of an energy storage system (“ESS”) in some embodiments. An ESS includes various components associated with transmitting energy to and from the vehicle propulsion battery 108, including, but not limited to, safety components, cooling components, heating components, rectifiers and combinations thereof.

The battery 108 may include one or more electrical cells. In some examples, the battery 108 includes a plurality of lithium ion cells coupled in parallel and/or series or both. The battery 108 may include cylindrical or flat electrical cells. In some examples, flat cells, also known as prismatic cells, are provided in a stack, positioned perpendicular to their major surfaces. A flat cell is an object having major first and second surfaces that are generally parallel to one another. The thickness of the flat cell is the distance between he first and second major surfaces. This thickness is generally smaller than the perimeter dimensions of either of the first or second major surfaces. A stack refers to a configuration of cells, such that the cells are placed onto one another in alignment. In some stacks, each of the cells has a face having a perimeter, and each of these perimeters is substantially adjacent and coextensive. The present subject matter should not be construed to be limited to the configurations disclosed herein, as other configurations of a vehicle propulsion battery 108 are possible. In various embodiments, the cells are fixedly disposed in a housing. Such configurations include, but are not limited to, potting, and mechanical fasteners such as straps or bands, each to secure or fix the location of the cells with respect to the housing.

Cell voltage at charge may typically range from around 2.8 volts to around 4.3 volts in use. In some examples, this is because cells age and become less effective, however other factors may also contribute to multiple cells having different voltages. Because the charged voltage of batteries ranges from cell to cell, some embodiments include one or more voltage management systems to maintain a steady voltage between cells or groups of cells. Some embodiments connect 9 battery cells in series to define a module. Such a module may have around 35 volts. Some instances connect 11 modules in series to define the battery of the ESS. The ESS may provide around 400 volts.

The ESS may include a state-of-charge circuit (not shown) to monitor the state of charge of the battery 108. The state-of-charge circuit may count coulombs, watt-hours, or provide other measure of how much energy is in the battery 108. In some embodiments, the state of charge is determined by measuring the battery voltage either open-circuited or driving a known load. In additional embodiments, the state-of-charge circuit may optionally provide additional battery information, such as temperature, rate of energy use, number of charge/discharge cycles, and other information relating to battery state.

Additionally illustrated is an energy converter termed a power electronics module, (PEM) 104. The PEM 104 is part of a system which converts energy from the vehicle propulsion battery 108 into energy useable by the at least one propulsion motor 106, and vice versa. The energy converter 104 may include transistors. Some examples include one or more field effect transistors. Some examples include metal oxide semiconductor field effect transistors. Some examples include one more insulated gate bipolar transistors. In various examples, the PEM 104 may include a switch bank which is configured to receive direct current power from the vehicle propulsion battery 108 and to output a three-phase alternating current to power the vehicle propulsion motor 106. In some examples, the PEM 104 may be configured to convert a three-phase signal from the vehicle propulsion motor 106 to DC power to be stored in the vehicle propulsion battery 108. Some examples of the PEM 108 convert energy from the vehicle propulsion battery 108 into energy usable by electrical loads other than the vehicle propulsion motor 106. Some of these examples switch energy from approximately 390 Volts DC to 14 Volts DC.

The propulsion motor 106 may be a three-phase AC induction motor. Some examples include a plurality of such motors, such as to drive multiple wheels of a vehicle. The present subject matter may optionally include a transmission or gearbox 110 in certain examples. While some examples include a 1-speed transmission, other examples are contemplated. Various transmissions may be used with the present subject matter including, but not limited to, manually clutched transmission, transmissions with hydraulic, electric, electrohydraulic clutch actuation, and some with dual-clutch systems. Rotary motion is transmitted from the transmission 110 to wheels 112 via one or more axles 114, in various examples. A differential 115 may optionally be used.

A vehicle management system 116 is optionally provided that provides control for one or more of the vehicle propulsion battery 108 and the PEM 104. In certain examples, the vehicle management system 116 is coupled to vehicle systems which monitor other safety systems such as one or more crash sensors. In some examples the vehicle management system 116 is coupled to one or more driver inputs, such as acceleration inputs. The vehicle management system 116 is configured to control power to one or more of the vehicle propulsion battery 108 and the PEM 104, in various embodiments.

A temperature control system 150 may control the temperature of the battery 108, and may heat or cool the battery. The temperature control system 150 is at least partially external to the battery 108. That is, a fluid that enters or exits the battery 108 may be heated or cooled by the temperature control system 150. The temperature control system 150 may optionally control the temperature of the PEM 104 and/or the motor 106.

The temperature control system 150 is pictured as one component that controls temperature for components 104, 106 and 108. Multiple control systems may be used, each for one or more components.

Some embodiments of the temperature control system 150 include a fin system (not shown) to control temperature using convection. Additional embodiments include a cooling system to conduct heat from the battery 108 using circulating liquid. A refrigeration system of the temperature control system 150 may include a compressor powered by an electric motor that is powered by the battery 108. Some embodiments include a heating system (not shown) to heat the battery 108. The heating system may include electric heating elements that are powered by the battery 108. Battery heating is useful to heat a battery when the ambient temperature is below a predetermined temperature.

The temperature control system 150 may optionally cool or warm a cabin 158 of the vehicle 100, such as by blowing cooled or warmed air through one or more ducts such as duct 154. Temperature control of the cabin 158 may occur at the same time as controlling the temperature of the power train components of the vehicle, including, but not limited to, the PEM 104, the motor 106 and the ESS 108.

In some embodiments, the temperature control system 150 includes a heat exchanger 152 external to the cabin 158 for shedding heat. In various embodiments, the heat exchanger is part of a heating, ventilation and air conditioning (“HVAC”) system. This heat exchanger 152 is coupled to other portions of the temperature control system 150 via coolant tubes 156 and 156′. This heat exchanger 152 may be a part of a refrigeration system, or it may be a fluid cooling system that circulates fluid to cool one or more of the power train components.

The temperature control system 150 may absorb heat from the battery 108. The temperature control system 150 includes one or more cooled heat conductors in thermal communication with the battery 108 and which cool the battery 108. Thermal communication with respect to conduction may include touching or it may include conduction via a thermal interface material. In some embodiments, cooling is provided by directing fluid that is cooler than the electrical cells of the battery 108 through the heat conductors and adjacent the electrical cells of the battery 108 so that heat is conducted out of the electrical cells and into the fluid of the temperature control system 150.

External power 118 may be provided to the PEM 104 to charge the battery 108. The PEM 104 may convert energy into energy that may be stored by the battery 108. In various embodiments, external power 118 includes a charging station that is coupled to a municipal power grid. In certain examples, the charging station converts power from a 110V AC power source into power storable by the vehicle propulsion battery 108. Some embodiments include converting energy from the battery 108 into power usable by a municipal grid using the PEM 104. The present subject matter is not limited to examples in which a converter for converting energy from an external source to energy usable by the vehicle 102 is located outside the vehicle 100, and other examples are contemplated.

Some examples include a vehicle display system 126. The vehicle display system 126 includes a visual indicator of system 102 information in some examples. In some embodiments, the vehicle display system 126 includes a monitor that includes information related to system 100. The vehicle display system 126 may include information relating to vehicle state of charge.

FIG. 2 is top view of a battery 108 containing a plurality of battery cells (cell 202 is typical) and heat conductors 204 and 206, according to some embodiments. The battery includes heat conductors 204 and 206 that are used to transfer heat to or from the battery cells. The cells are otherwise in poor thermal communication with one another. The heat conductors 204 and 206 and the poor thermal communication between cells helps to prevent a chain reaction whereby a first cell in thermal runaway starts neighboring cells into thermal runaway. This allows for improved volumetric energy density of the battery 108, as is further described below.

The plurality of cells and the heat conductors are internal subcomponents of the battery 108 illustrated in FIG. 1. The cells illustrated are cylindrical cells. These may be jelly-roll cells, but other cylindrical cells, such as button cells, are possible. The cells may also be flat cells.

The cells 202 include an anode pad 215 (typical) and an electrical insulator 218 (typical). The electrical insulator may be shrink-wrap, paper, a coating, or combinations thereof. Additionally, embodiments that do not use an electrical insulator are possible. In embodiments without electrical insulators, electrically insulative potting material may be used to insulate the cell exterior. Some embodiments use a thermally insulative potting material as disclosed herein.

The anode pads 215 are shown interconnected to cathode pads (217 is typical) to create a battery from a one or more series of interconnected cells. The cells may be interconnected in series via busbars (220 is typical). The cells may also be connected in parallel. In some embodiments, heat conductors 204 and 206 function as electrical busbars.

The cells heat up and cool down in use. Further, if they fail, they may generate excessive heat, a phenomenon known as thermal runaway, (“TR” ). Heat conductors 204 and 206 are part of a system that is designed to control the temperature of a cell in TR as well as its neighboring cells.

The heat conductors 204 and 206 may include, but are not limited to, a thermally conductive potting material, a busbar, a heat pipe or another vessel or tube. A vessel is a fluid conduit. Multi-chamber conduits are possible. Some conduits flow fluid in a single direction, while others flow fluids in two simultaneous directions providing fluid cross-flow. In cross-flow embodiments, the conduits are adjacent to one another, and fluid flows in a first direction in a first chamber, and in a second direction in a second chamber.

In some examples, when a cell is in TR, fluid in the heat conductors boils. If the flow passageways are too small, surface tension effects will not allow fluid to flow around bubbles that are generated. If this happens, the section of cooling tube in communication with the runaway cell may become devoid of fluid and the rate of heat transfer from the runaway cell to the fluid will decrease. Accordingly, the cross section should be sized to allow for fluid flow during boiling. Additionally, the vessel(s) may be positions so that the movement of fluid and bubbles is assisted by gravity such as by orienting the vessel (i.e., making it not level) so bubbles will move along its length during use, such as when a vehicle, that includes the vessel, is not on an incline.

In various embodiments, heat conductors 204 and 206 are formed from a metal such as aluminum. Some embodiments use extruded aluminum. Some embodiments use thermally conductive busbars (i.e., busbar 220) that do not flow fluid. Some busbar embodiments include copper.

In various embodiments, the heat conductors 204 and 206 bend around a contour of a cell to contact a cell, such as cell 224, along an arc of the cell 224 exterior, creating an interface through which thermal energy may be transferred, such as by conduction. The heat conductors 204 and 206 transfer heat well and provide a heat transfer path from a cell to another cell or cells and/or to a heat exchanger. Since the heat transfer path from cell to neighboring cell has more thermal resistance than the heat transfer path to the heat conductor from a cell, heat flow is encouraged to be from a cell and into the heat conductors 204 and 206 rather than from a cell to another cell.

A cell may abut (i.e., physically touch) the heat conductor, or may substantially abut the heat conductor, when small gaps exist between a cell and a heat conductor. Examples of scalloped tubing are disclosed in U.S. patent application Ser. No. 11/820,008, entitled, “Optimized Cooling Tube Geometry For Intimate Thermal Contact With Cells,” filed Jun. 1, 2007, which is commonly assigned and which is incorporated herein by reference in its entirety. The heat conductor may have a high aspect ratio such that it extends a significant portion of the axial height of the cell, but is thin in the radial cell dimension to promote high volumetric packing density of the cells.

In various embodiments, a first row 208 of cells abuts a first heat conductor 204, and a second row 210 of cells is adjacent the first heat conductor 204. Similarly, a third row 212 is adjacent a second heat conductor 206, as is a fourth row 214. Adjacent cells are those that are abutting a heat conductor and those that are nearby but not abutting, such as when a material is disposed between them.

A thermal interface material 216 may be introduced between a cell 202 and a heat conductor 204. This material may include a structure coated in a thermal grease. Further embodiments include an adhesive. Some embodiments include a potting material or encapsulant, such as an epoxy. Two-part epoxies are used in come embodiments. Some examples that include epoxy use STYCAST epoxies such as STYCAST 2850 KT, manufactured by Emerson and Cuming. Solder may also be used.

In some examples, this material 216 compensates for unwanted air gaps. A silicon sealant or cushion may be used to fill air gaps. In some of these examples, a closed-cell silicone sponge rubber is used. Some embodiments use THERMACOOL R-10404 Gap Filler, available from SAINT-GOBAIN, to provide thermal conductivity. Embodiments including a compliant material disposed between a cell and a heat conductor benefit from increased resistance to cell repositioning and/or terminal damage due to vibration. Additional benefits of the compliant material is that the material may accommodate assembly tolerance as well as geometric changes due to thermal expansion and contraction. The heat conductor 216 is compliant and is shown complying 220 to the shape of the heat conductor 204 and the cell 202.

Material 216 may be electrically insulative to electrically isolate the cell 202 from the heat conductor 204. Some embodiments use materials that are flame retardant. Some embodiments do not use a material 216 between the heat conductor 204 and the cell 224, and instead place the cell 224 in direct contact 218 with the heat conductor 204.

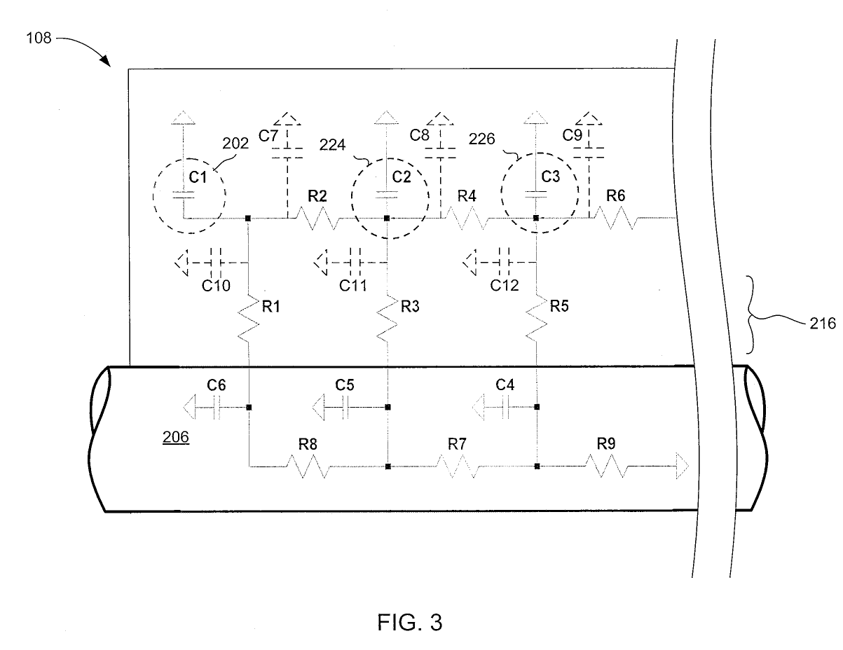

The cells 224 and 226 are located in close proximity to one another, separated by a distances D₁. The cells in a row are also located in close proximity to one another, separated by an air gap D₂. The sizes of the air gaps D₁ and D₂ are selected based on considerations discussed in associated with FIGS. 3-10. The air-gaps exist to discourage conduction across distances D₁ and D₂. The thermal resistivity between cells may be further increased by disposing material that has a thermal resistivity that is higher than that of the ambient atmosphere and/or is not in thermal conduction with the cells between the cells. Materials possible include, but are not limited to, ceramics, silicone and fiberglass. The material may optionally be flame retardant. To decrease heat transfer via radiation, coating or surface preparations may be used. For example, some embodiments include cells that have a polished metallic exterior that reduces thermal radiation emission and promotes thermal radiation reflection relative to other cell surface materials or preparations.

FIG. 3 is a schematic of a plurality of battery cells and a heat conductor 206, according to some embodiments. The diagram is representative of a cell 202 in a battery housing. Because cell 202 does not have a cell on each side of it (i.e., cell 224 is on one side, and no cell is on the opposite side) it represents a cell disposed in a corner of a battery housing. The corner condition is a worst case scenario in some examples, as the number of paths for heat conduction away from a cell are limited.

The present inventors have recognized that if a battery 108, is formed of a plurality of cells, and one of the cells, for example cell 202, goes into thermal runaway (TR), the cell 202 in TR may raise the temperature of other cells nearby the cell (e.g., cell 224) such that the nearby cells are catalyzed into TR. Accordingly, various embodiments increase the rate at which a cell in TR cools. Various embodiments also decrease the rate at which a first cell may heat a second cell directly (i.e., not via a heat conductor). Some embodiments combine these two improvements to reduce the tendency of a first cell that is TR to put a second cell into TR.

The improvements set out here provide electrochemical cells of high gravimetric energy density, such as lithium cells, that may be integrated into an application such as an electric vehicle at high volumetric energy density due to closer packing. The volumetric energy density is improved because cells of a battery may be positioned closer to one another than in embodiments that do not include these improvements.

One way in which the present embodiments resist propagation of TR is by providing a high ratio of thermal resistance between a cell in TR and a neighboring cell to thermal resistance between the cell in TR and a heat conductor. In the symbolism of FIG. 3,

$$\frac{R 2}{R 1} \geq 1 \qquad ( 1 )$$

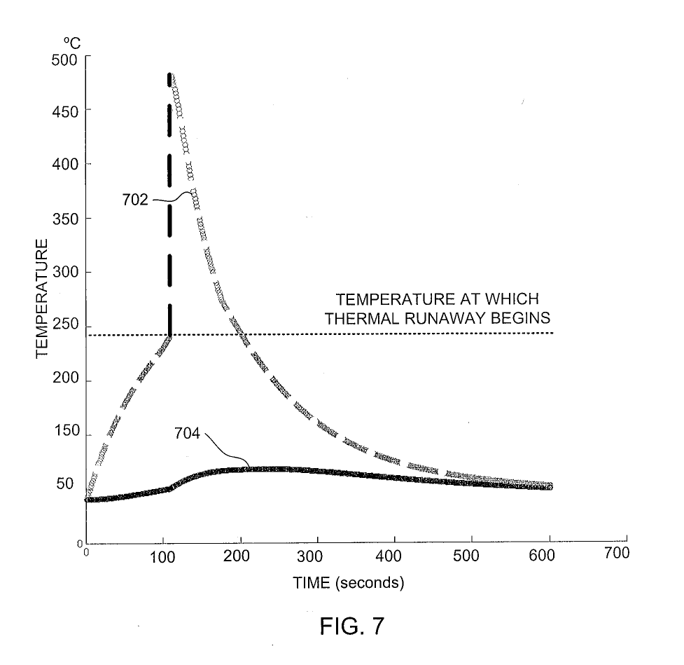

In some examples, this ratio is approximately 1, and in additional examples it is higher than one. A theoretical model illustrated in FIGS. 7-10 shows batteries which have a ratio of 0.7, which is not a preferred ratio, and batteries that have a ratio is 5.0. A ratio that is higher than 5.0 is desirable. A ratio greater than or equal to 10 is used if packaging permits. If packaging does not permit, in some embodiments, cells having lower gravimetric energy density may be used to decrease temperatures exhibited during TR and/or increase the onset temperature of TR. Alternatively, fewer cells that are spaced farther apart may be used, decreasing the energy storage capacity of the battery.

According to the ratio of equation 1, heat energy from the cell in TR is more easily conducted to heat conductor than it is to a neighboring cell. This is because there is an air gap between the cells causing a high R2 value (thermal resistivity), and because the cells are adjacent a heat conductor to conduct heat into the heat conductor, resulting in a lower R1 value. This increases the amount of heat that goes into the heat conductor 206 and decreases the amount of heat that goes into the neighboring cell 224. The air-gap distance D₁, in various embodiments, is sufficient to restrict heat flow from the first cell to the second cell during a thermal runaway event of the first cell, the heat flow restricted such that the second cell temperature remains less than a temperature sufficient to cause thermal runaway in the second cell. This is an improvement over batteries in which neighboring cells are potted in a material that has an R value lower than air.

A further benefit is that when R2 is high, the heat transfers to cell 224 more slowly. This allows the cell 224 to distribute heat energy around its structure more gradually. This may avoid a hotspot. A hotspot is where a portion of the cell goes into TR, causing the remainder of the cell to go into TR.

In addition to thermally insulating neighboring cells from one another, the present subject matter provides for heat to be stored and conducted away from a cell in TR. First, FIG. 3 illustrates that the cell 202 itself has a thermal capacitance C1 and may therefore absorb some heat. The diagram also shows that the optional thermal interface material (“TIM” ) 216 also has an thermal capacitance C10 and may therefore absorb heat. In some embodiments the TIM includes a phase-change material to provide for capacitance, but the present subject matter is not so limited.

The material 216 is illustrated having three thermal resistances, R1, R3 and R5 and three thermal capacitances C10, C11 and C12. These are approximations used to provide the data of FIGS. 7-10. The data of FIGS. 7-10 is based on a theoretical model. Physically, the material 216 may be a monolithic piece (i.e., a piece cut or molded into a single piece), but thermally it substantially behaves according to the schematic representation.

The material 216 between a heat conductor and a cell may break down at a predetermined temperature to provide a reduced thermal conductivity above that temperature. In some of these embodiments, the predetermined temperature may be selected so that a material between a neighboring cell and the heat conductor does not break down. The cell in TR is therefore more thermally isolated from the remainder of cells in a battery, and it may transfer its heat to the heat conductor 206 and therefore to surrounding cells 224 and 226 at a rate which does not put the surrounding cells into TR. The good thermal communication between each of the neighboring cells and the heat conductor and the slow rate of heat transfer from the runaway cell allows the neighboring cells to remain approximately isothermal with the fluid (i.e., R2 and R4 are high relative to R1, R3 and R5).

In some embodiments, natural convection within a fluid in a heat conductor transports the heat from the neighboring cells throughout the rest of the battery, draining away the heat from the cell in TR (i.e., R7-R9 are small). The ratio of R2/R3 should remain high so that the thermal resistance R2 to the runaway cell is high and the thermal resistance R3 to the fluid is low.

In various embodiments, a heat conductor is provided that has a high heat capacitance, A high heat capacitance allows for a heat conductor to absorb more heat energy. The capacitance is represented by C4, C5 and C6. This is a modeled representation, and physically, the heat conductor is either a monolith, or a tube filled with liquid (or liquids in multi chamber embodiments).

To provide a high heat capacitance, some heat-conductor 206 embodiments use one or more bodies of liquid that enter into a phase change at a predetermined temperature. The temperature at which fluid in a heat conductor reaches its boiling point is higher than normal, and is below the temperature neighboring cells will reach while the cell is in TR. A fluid having a predetermined phase-change temperature is selected so that it enters phase change during thermal runaway. Various embodiments use a cooling fluid that has a depressed boiling point due to the use of a volatile fluid or a miscible or immiscible mixture of fluids with a lower combined boiling point. Fluids with higher specific latent heats of vaporization are also usable.

Some embodiments use a tube shaped to reduce instances of bubbles in the fluid, so as to not create hot spots in the heat conductor. A hot spot is a spot that has an air bubble and therefore an increased R value. Various embodiments are shaped so that there are no elevated portions, with a high spot of the portion being higher in elevation than the inlet to the portion and the outlet from the portion. In some embodiments, one of the inlet and the outlet is higher than the other, and there are no high spots between them. Some configurations include two or more of these features.

In various embodiments, a material between a cell and a heat conductor has a heat capacitance C10 that is greater than the heat capacitance C7 between neighboring cells and that is substantially equivalent to the heat capacitance C1 of the cells. In these embodiments, convection and radiation shielding material disposed between neighboring cells that provides for a large R2 may also have high heat capacitance, such as a phase-change material. The high lumped RC of R2 and C10 relative to the smaller lumped RC of R1 and C7 and the RC of R3 and C8 further retard heat accumulation in the neighbor cell 224 while 202 is in TR.

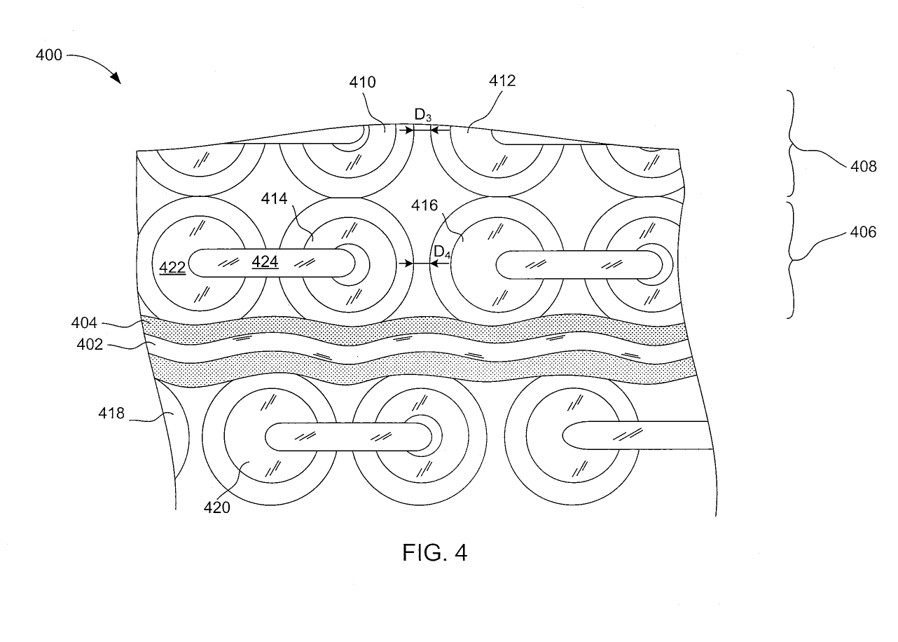

FIG. 4 is a schematic of thermal relationships between a plurality of battery cells (414 is typical of a cell) and a heat conductor 402, according to some embodiments. A first row of cells 406 is shown aligned with a second row of cells 408. The first row of cells 406 is show abutting the second row of cells 408 such that abutting cells are in thermal conduction with one another. A TIM may optionally be disposed between cells, such that cells in a first row sandwich a TIM against cells in a second row.

The first row of cells 406 is shown also abutting a thermal interface material 404 which is shown abutting a heat conductor 402. Neighboring cells 410 and 412 are separated by a distance D₃. Further neighboring cells 414 and 416 are shown separated by a distance D₄. These distances are equal in some examples, although embodiments in which they are not equal are possible. For example, in some embodiments, the cells are not of equal diameter.

In various embodiments, both of the distances D₃ and D₄ are selected such that the both cells 412 and 416 do not reach the onset temperature for TR when one or both of cells 410 and 414 are in TR. For example, for a predetermined thermal resistivity between cell 410 and 414 and between cell 414 and thermal interface material 404 and heat conductor 402, and for a predetermined thermal capacitance of cells 410 and 414 and thermal interface material 404 and heat conductor 402, the distance D₃ and D₄ are selected so that their temperature remains below a predetermined temperature during TR for one and/or both of cells 410 and 414. Although two rows 406 and 408 are shown stacked onto one another, the present subject matter is not limited to two rows stacked onto one another, as rows of three or more are also possible. Embodiments including other configurations of cells are also possible.

In one embodiment, cell 418 is electrically connected to cell 422, which is electrically interconnected to cell 420. Electrical interconnect 424 is not used. In this embodiment, intra-cell electrical interconnects traverse the heat conductor 402. This may increase the thermal resistivity across distances D₃ and D₄, which may increase the volumetric energy of battery packs by allowing cells to be packaged closer to one another without providing for TR chain reactions via thermal conduction.

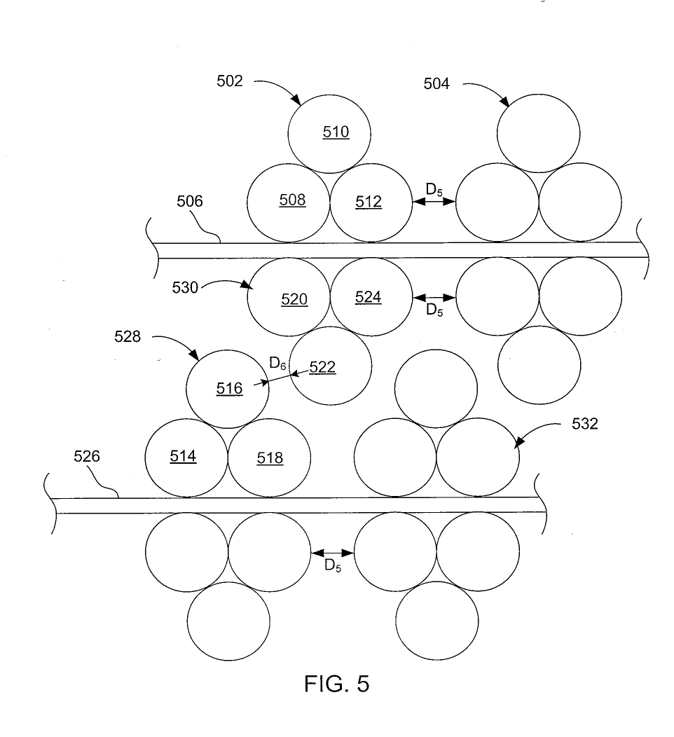

FIG. 5 shows a top view of an additional configuration of cells, according to some embodiments. A first nested cluster of cells 502 is shown adjacent to and in thermal communication with a heat conductor 506. A second nested cluster of cells 502 is shown adjacent to and in thermal communication with a heat conductor 506. Further clusters are also illustrated, including clusters 528 and 532. Cluster 530 is shown aligned between clusters 528 and 532 without abutting them, and is separated from each by at least the distance D₃. Within each cluster, include individual cells may be electrically interconnected to one another in series or in parallel.

The cluster additionally may be electrically coupled to one another. In some examples, clusters 502 and 530 are electrically coupled to one another across a heat conductor 506. For example, in some embodiments, cluster 502 is electrically coupled to cluster 530 across heat conductor 506. Further, cluster 530 may be electrically coupled to cluster 504 across heat conductor 506. This zig-zag configuration reduces instances of an electrical interconnect providing a thermally conductive path between neighboring clusters (e.g., clusters 502 and 504). In embodiments where an electrical interconnect crosses a heat conductor, the electrical interconnect is electrically isolated from the heat conductor. By interconnecting clusters across a heat conductor, the volumetric energy density of the battery pack may be increased by allowing cells to be packed in closer proximity to one another without providing for TR chain reactions. Embodiments that include electrical interconnects that do not cross a heat conductors are possible.

Neighboring clusters 502 and 504 are separated by a distance D₅. In various embodiments, the distance D₅ is selected such that the cells of cluster 504 do not enter TR when one or all of cells 508-512 enter TR. For example, for a known thermal resistivity between cluster 502 and 504 and between cluster 502 and heat conductor 506, and for a known thermal capacitance of clusters 502 and 504 and heat conductor 506, the distance D₅ is selected so that their temperature remains below a predetermined temperature during TR for at least one of the cells in cluster 502. In various embodiments, the distance D6 is similarly selected so that if one or more of the cells in one of the clusters 528, 530 enters TR, it does not start a chain reaction of cells in TR in the other cluster.

The configurations illustrated in the embodiments of FIGS. 2-6 are only some of the possible configurations to take advantage of good conductivity to a heat conductor and poor conductivity between spaced-apart cells and/or clusters of cells. Other numbers of cells, numbers of clusters and/or numbers of cells in clusters can be used with the present subject matter. Further, the heat conductors disclosed herein may wind through cells rather than being linear or substantially linear as illustrated in these figures.

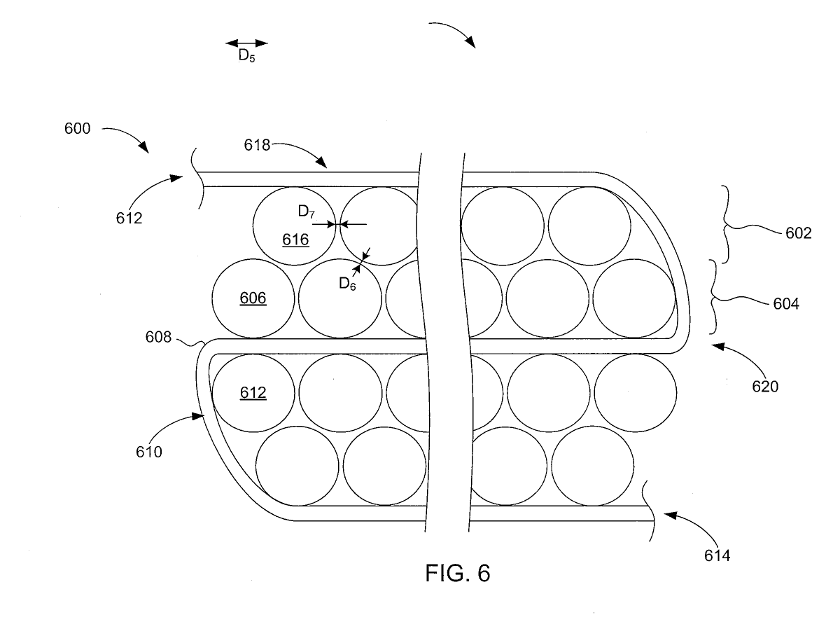

FIG. 6 shows a top view of an additional configuration of cells (606 is typical), according to some embodiments. The battery pack 600 includes at least a first row 602 that is nested with at least a second row 604. In the embodiment, the first and second rows each contact a heat conductor, such as conductor 608. In the first row, each of the cells is spaced from one another by a minimum predetermined air gap D₇. The second row is spaced apart form the first row at least by a minimum predetermined air gap D₆. In some embodiments, D₆ and D₇ are substantially the same, although embodiments are possible in which they are not the same. The heat conductor 608 can include a curve that follows the contour of several cells, as illustrated. As such, in some embodiments, the corner or end cell 612 contacts the heat conductor 608 in two places, which can increase the rate of heat conduction. Although a single heat conductor is illustrated, embodiments are possible in which multiple heat conductors are used. In various embodiments, a first battery cell 616 is in a first row 602 that is nested with a second row 604 including the second battery cell 606. In various embodiments, the heat conductor 608 extends along a first side 618 of the cells of the first row and a second side 620 of the cells of the second row 604 that is opposite the first side, with the rows 602 and 604 in between the first 618 and second 620 sides. In various embodiments, the heat conductor forms an approximate U-shape that sandwiches the first 602 and second 604 rows.

As disclosed herein, in some embodiments, a first portion 612 of the heat conductor is elevated over a second portion 614 so that bubbles travel in the heat conductor when the battery pack 600 is level.

FIG. 7 is a graph is a time vs. temperature graph showing a cell 402 at a normal state of charge that enters TR, and a cell 404 at a normal state of charge that does not enter TR. A ratio of thermal resistivity between cells to that of a cell and a heat conductor is high. The equation (1) ratio between them is approximately 5.0.

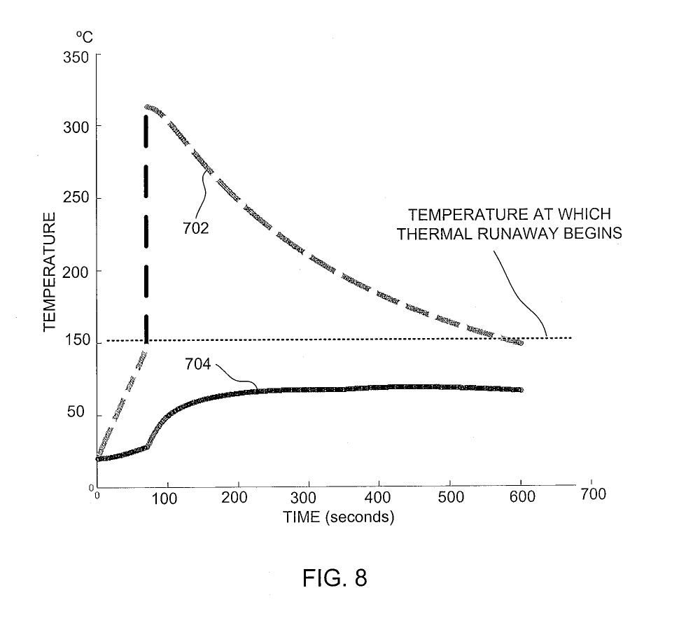

FIG. 8 is a time vs. temperature graph showing a cell 402 at a normal state of charge that enters TR, and a cell 404 at a normal state of charge that does not enter TR. FIG. 6 represents a conventional design. A ratio of thermal resistivity between cells to that of a cell and a heat conductor is low. The equation (1) ratio between them is approximately 0.7.

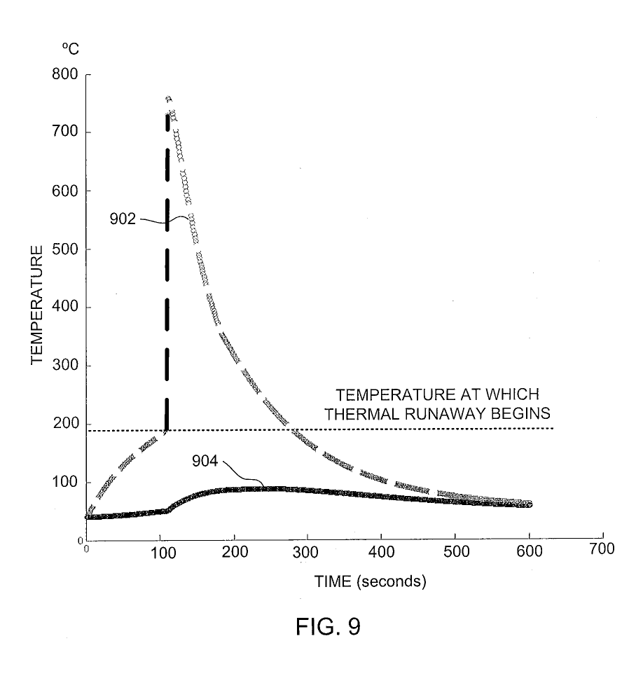

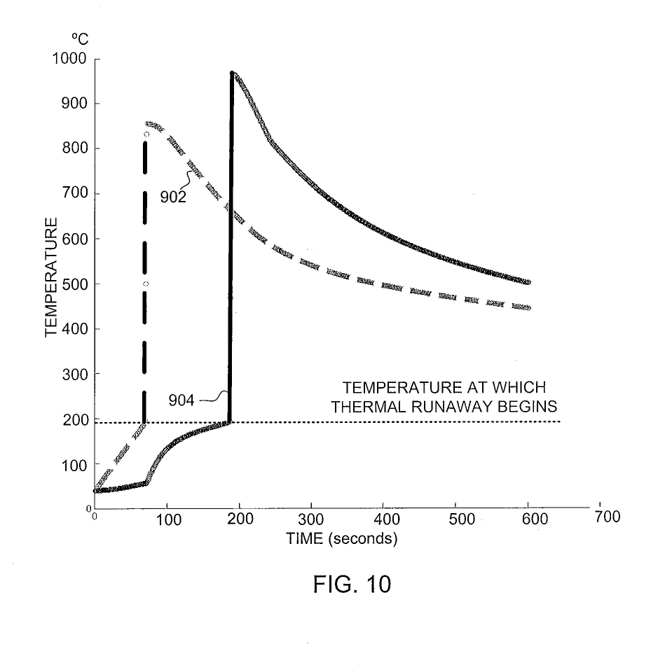

FIG. 8 shows that a system without a low equation 1 ratio will not incite a chain reaction of TR when cells are at a normal state of charge. This is not true for when the cells are at a high state of charge, as is pictured in FIGS. 9-10. These figures show that the higher ratio prevents a chain reaction.

FIG. 9 is a time vs. temperature graph showing a cell 602 at a high state of charge that enters TR, and a cell 604 at a high state of charge that does not enter TR, with a high ratio of high thermal resistivity between cells to that of a cell to a heat conductor, according to some embodiments. The equation (1) ratio between them is approximately 5.0.

FIG. 10 time vs. temperature graph showing a cell 602 at a high state of charge that enters TR, and a cell 604 at a high state of charge that does not enter TR, with a low ratio of high thermal resistivity to a heat conductor to thermal resistivity with another cell. The ratio of thermal resistance between the cells in the graph is approximately 0.7. Cell 604 has been caused to enter TR by cell 602. As is demonstrated when FIG. 10 is compared to FIG. 9, the higher equation (1) ratio is more likely to protect cell 604 from TR.

FIGS. 7-10 show that for cells that are not charged to the high state of charge illustrated in FIGS. 9-10, the low equation 1 ratio is acceptable. However, if the cells are charged to a higher energy state, there is a risk of a first cell in TR putting a neighboring cell into TR. Accordingly, the thermal resistivity and capacitance between cells and between a cell and a heat conductor may be adjusted to allow a desired energy density that avoids TR chain reactions in application.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. An apparatus, comprising:
a battery housing;
a first battery cell having a first cell thermal capacitance, the first cell fixedly disposed in the battery housing;
a second battery cell having a second cell thermal capacitance, the second cell fixedly disposed in the housing a minimum air gap away from the first cell, the minimum air gap having an air gap thermal resistance; and
a heat conductor disposed adjacent each of the cells, with the heat conductor having a heat conductor heat capacitance,
wherein a combination of the first cell thermal capacitance, the second cell thermal capacitance, the heat conductor thermal capacitance and the air gap is sufficient to restrict heat flow from the first cell to the second cell during a thermal runaway event of the first cell, the heat flow restricted such that the second cell temperature remains less than a temperature sufficient to cause thermal runaway in the second cell.

2. The apparatus of claim 1, wherein the heat conductor includes a fluid cooling tube.

3. The apparatus of claim 2, wherein the fluid cooling tube includes a fluid adapted to phase change before the temperature sufficient to cause thermal runaway.

4. The apparatus of claim 2, wherein the fluid cooling tube is part of a coolant circulation system adapted to circulate fluid through the fluid cooling tube.

5. The apparatus of claim 1, wherein the first battery cell is in a first row of cells that is nested with a second row of cells including the second battery cell, with the heat conductor sandwiching the first and second rows.

6. The apparatus of claim 1, wherein the first cell is in a first cluster in which a plurality of cells are abutting in thermal conduction with one another and the second cell is in a second cluster in which a plurality of cells are abutting in thermal conduction with one another.

7. The apparatus of claim 1, wherein the battery housing has a housing heat capacitance, and the combination includes the housing heat capacitance.

8. An apparatus, comprising:
a battery housing having a housing heat capacitance;
a first battery cell having a first thermal capacitance, the first cell fixedly disposed in the battery housing;
a second battery cell having a second thermal capacitance, the second cell fixedly disposed in the housing a minimum air gap away from the first cell, the minimum air gap having an air gap thermal resistance;
a heat conductor disposed adjacent each of the cells, with the heat conductor having a heat conductor heat capacitance; and
a thermal interface material disposed between the heat conductor the first cell and between the heat conductor and the second cell and not between the first cell and the second cell, the thermal interface material conformed to the heat conductor and each of the first and second cells.

9. The apparatus of claim 8, wherein the heat conductor includes scallops.

10. The apparatus of claim 8, wherein the thermal interface material comprises a foam that is pliable and resilient.

11. The apparatus of claim 8, wherein the thermal interface material is adapted to break down at a predetermined temperature.

12. The apparatus of claim 8, wherein the thermal interface material includes an adhesive that includes an epoxy.

13. The apparatus of claim 12, wherein the adhesive is a two-component, epoxy encapsulant that has a low coefficient of thermal expansion and is dielectric.

14. The apparatus of claim 12, wherein the thermal interface material includes a ceramic-filled silicone rubber.

15. The apparatus of claim 8, wherein the heat conductor is coupled to a an external temperature control system that extends external the housing.

16. The apparatus of claim 15, wherein the external control system includes a fluid recirculation system to cycle a fluid through a fluid cooling tube that is adjacent the first and second cells.

17. An electric vehicle, comprising:
an electric motor coupled to propel the electric vehicle;
a battery housing disposed in the electric vehicle, the battery housing including a plurality of battery cells to power the electric motor;
a first cell of the plurality of battery cells, the first cell having a first cell thermal capacitance, the first cell fixedly disposed in the battery housing;
a second cell of the plurality of battery cells, the second cell having a second cell thermal capacitance, the second cell fixedly disposed in the housing a minimum air gap away from the first cell, the minimum air gap having an air gap thermal resistance; and
a fluid cooling tube disposed adjacent each of the cells, with the cooling tube having a cooling tube heat capacitance, the cooling tube being part of a temperature control system to cool the cooling tube,
wherein a combination of the first cell thermal capacitance, the second cell thermal capacitance, the heat conductor thermal capacitance and the air gap is sufficient to restrict heat flow from the first cell to the second cell during a thermal runaway event of the first cell, the heat flow restricted such that the second cell temperature remains less than a temperature sufficient to cause thermal runaway in the second cell.

18. The electric vehicle of claim 17, wherein the temperature control system is coupled to a heat exchanger.

19. The electric vehicle of claim 17, wherein the temperature control system includes a liquid temperature control system coupled to a heating, ventilation and air conditioning (“HVAC” ) heat exchanger.

20. The electric vehicle of claim 17, wherein the temperature control system is to cool the electric motor.
